(19) United States
(12) Patent Application Publication
(10) Pub. No.: US 2007/0085650 A1
(43) Pub. Date: Apr. 19, 2007

(54) QQ-type spirakore

(76) Inventor: Chiu-Nan Chen, Taipei City (TW)

Correspondence Address: Chiu-Nan Chen, P.O. Box No. 6-57, Junghe, Taipei, 235, TW

(21) Appl. No.: 11/249,365

(22) Filed: Oct. 14, 2005

(51) Int. Cl. H01F 27/24

(52) U.S. Cl. 336/213; 336/212

(57) ABSTRACT

A QQ-type spirakore is made by winding a silicon steel strip or a non-crystal magnetic strip into an inner ring egg-shape spirakore embryo, and then cutting a middle section of the egg-shape spirakore embryo into two symmetric assembling bocks, so as to fix the two assembling blocks into a coil structure of a power factor corrector in a butted way. In addition to largely reduce a waste of material, the film-like QQ-type spirakore structure can also effectively reduce ill products. The magnetic crystal generated is a non-orientation structure, and the egg-shape spirakore is a structure without angles, which facilitate a guidance of air flow and a reduction to an unusual tone and low frequency ripple interference.

### BACKGROUND OF THE INVENTION

(a) Field of the Invention

The present invention relates to a coil type power factor corrector, and more particularly to an improvement to its spirakore structure so as to achieve purposes of reducing a waste of material, effectively controlling quality, increasing an efficiency of heat dissipating, and reducing an unusual tone and a low frequency ripple interference.

(b) Description of the Prior Art

A passive element like an inductor will usually be used in a power supply applied in an electronic device such as a personal computer or a server, to control/adjust an input time and mode of alternative current, such that the mode will be as consistent with that of a direct current as possible to facilitate the applied electronic device to improve its energy utilization. This effect is the so called PFC (Power Factor Correction).

Referring to FIG. 1, it shows a commonly used coil-type power factor corrector which is composed of a wire bundle wrapping a UU-type spirakore 10. As the electric field and the magnet field can be mutually converted, a magnetic field will be induced surrounding a conduction wire with an electric current flowing through. On the contrary, an electric current will be induced by cutting magnetic lines of force in a coil. Accordingly, a coil-type power factor corrector is constructed by winding conduction wires into coils which are close to one another. When an electric current flows through the coils, a magnetic energy will be filled into the coils. When the electric current is decreased, the magnetic energy in the coils will generate a force to stop a change of the electric current. Therefore, a primary function of a coil-type inductor is to filter noises in the electric current, and stabilize the electric current in a circuit, so as to prevent from an interference of an electro-magnetic wave, as well as to adjust a stability of the electric current by storing and releasing electric energy in the circuit. Accordingly, the coil-type inductor is widely used in devices including a power supply, a monitor, a switch box, a motherboard, a scanner, a telephone set, and a modem, etc.

The UU-type spirakore 10 of a conventional coil-type power factor corrector is composed of a U-type silicon steel block 11 which is formed by overlapping U-type silicon steel strips 111, and is then constructed by passing two U-type silicon steel blocks 11 into a wire bundle 20 in a butted way. However, the U-type silicon steel block 11 is constructed by overlapping every piece of silicon steel strip 111 which is formed by punching. Therefore, a large amount of waste material (about 30% ˜60%) will be generated during a process of manufacturing the silicon steel strip, which will cause a waste in raw materials and will increase its cost especially when the resource of silicon steel strips is in short. In addition, it is extremely easy to damage an insulation to form an ill product by breaking a slot of the coil structure due to a quality of silicon steel strip or carelessness in manufacturing, upon assembling.

Moreover, as the coil-type power factor corrector belongs to a magnetic element with high inductance, its common loss usually occurs at “copper loss” or “iron loss.” When the magnetic lines of force of the aforementioned U-type silicon steel strips cannot be tightly combined from inside to outside between the silicon steel strips, a magnetic resistance and a gap reactance will be generated. In addition, when a magnetic leakage dissipates extremely fast, heat dissipation will be slowed down if a magnetic circuit is not in order between the silicon steel strips, which will in turn affect an efficiency of heat dissipation of the applied electronic device.

### SUMMARY OF THE INVENTION

Accordingly, the present invention winds a steel strip or non-crystal magnetic strip of a specified breadth into an inner ring egg-shape spirakore embryo and cuts at a middle section of the egg-shape spirakore embryo into two symmetric assembling blocks, in order to fix the two assembling blocks in a coil structure of a power factor corrector in a butted way, thereby forming a complete QQ-type spirakore and constructing a QQ-type power factor corrector with the coil structure.

Accordingly, in addition to largely reduce a waste of material, the film-like QQ-type spirakore can also effectively reduce ill products. Moreover, the magnetic crystal generated is a non-orientation structure, and the QQ-type spirakore is a structure of an egg-shape without angles, which will facilitate a guidance of air flow and thus have a better effect of heat dissipating. On the other hand, an unusual tone and a low frequency ripple interference which are generated by an interlink of a magnetic leakage of magnetic lines of force of the assembling blocks with a casing of electronic device and peripheral elements can be prevented.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of structure of a conventional coil-type power factor corrector.

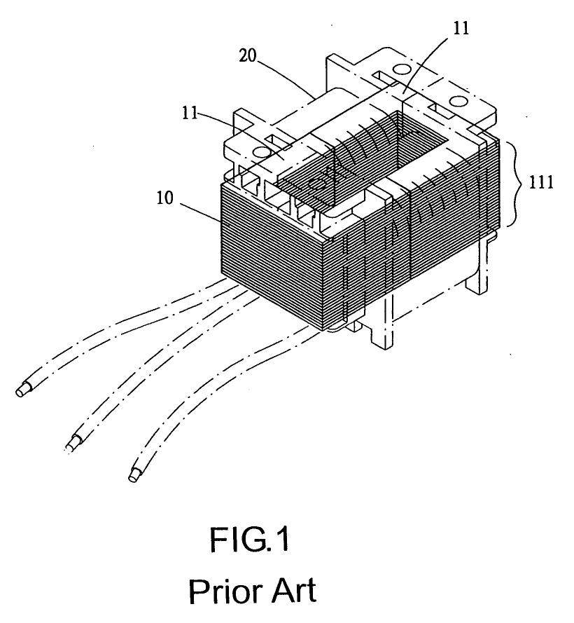

FIG. 2 shows a perspective view of a coil-type power factor corrector applying a QQ-type spirakore of the present invention.

FIG. 3 shows a perspective view of an egg-shape spirakore of the present invention.

FIG. 4 shows a schematic view of assembling a QQ-type spirakore of the present invention.

### DETAILED DESCRIPTION OF THE PREFERRED EMBODIMENTS

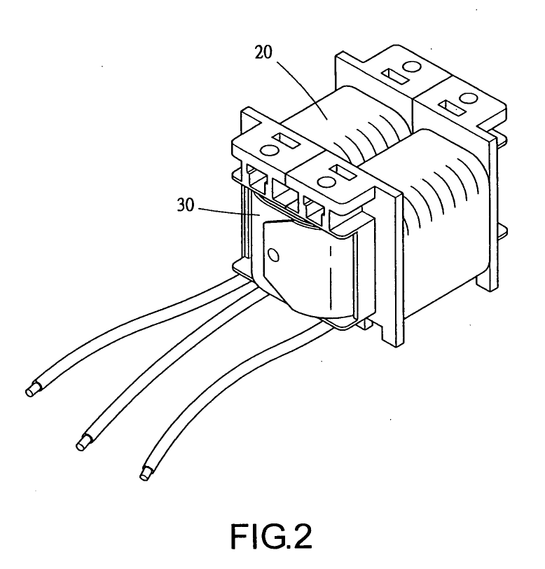

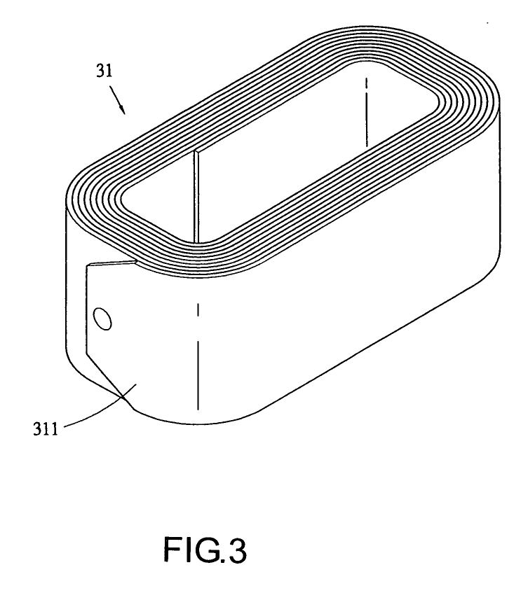

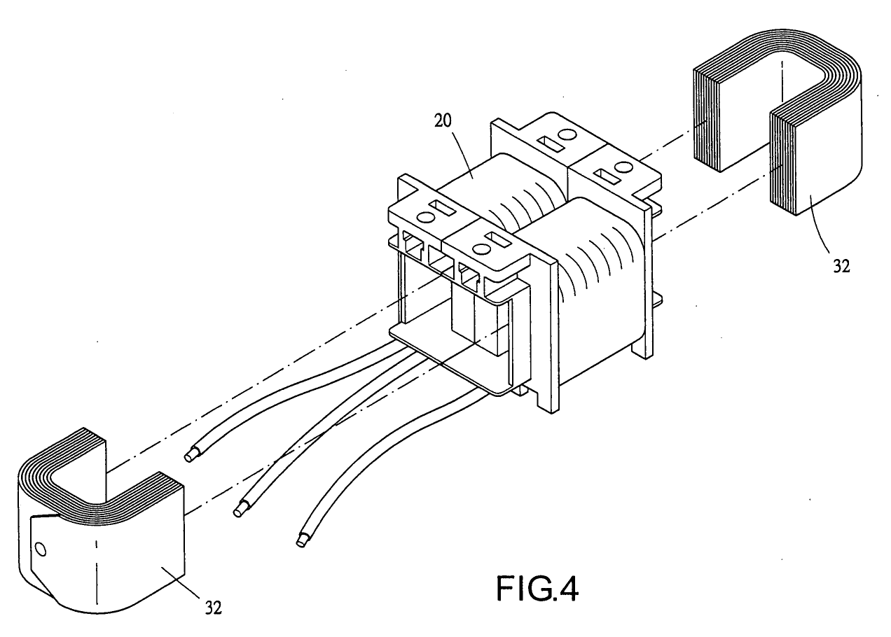

The present invention is to provide a spirakore structure which can reduce a waste of material and effectively control quality in a process of manufacturing, and can increase an efficiency of heat dissipating and reduce an unusual tone and low frequency ripple interference in a practical application. Referring to FIG. 2, a QQ-type spirakore 30 is surrounded by a coil 20 in a power factor corrector. As shown in FIG. 3 and FIG. 4, the entire QQ-type spirakore is basically made by winding a steel strip 311 of a specified breadth into an inner ring egg-shape spirakore embryo 31, and then cutting a middle section of the egg-shape spirakore embryo 31 into two symmetric assembling blocks 32, so as to fix the two assembling blocks 32 into the coil structure 20 of a power factor corrector in a butted way, thereby constituting a complete QQ-type spirakore structure 30 and assembling a QQ-type power factor corrector with the coil 20.

As the egg-shape spirakore embryo 31 for constructing the QQ-type spirakore 30 is made by winding a silicon steel strip of a specified breadth, it can largely reduce a waste of material and effectively reduce cost. Moreover, the film-like spirakore structure is tighter and more accurate, which is easier to assemble with the coil 20 and can effective reduce ill products. On the other hand, the magnetic crystal generated is a non-orientation structure, which can prevent generation of an unusual tone and a low frequency ripple interference by an interlink of magnetic leakage of magnetic lines of force of the assembling blocks with a casing of electronic device (such as a power supply) and peripheral elements.

It is worth mentioning that as a coil-type power factor corrector belongs to a magnetic element of a high inductance, its common loss usually occurs at “copper loss” or “iron loss.” On the other hand, in the film-like QQ-type spirakore structure of the present invention, the coils that generate heat (or wire bundles) are put in an outer layer of the assembling blocks. As each assembling block is an egg-shape structure without an angular magnetic leakage, an area of heat dissipating is larger, and a design of arc curvature facilitates a guidance of air flow, such that the heat is easier to be carried away by a flow of a fan inside an electronic device (such as a power supply), thereby enabling the applied electronic device to have a better efficiency of heat dissipation.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A QQ-type spirakore made by winding a silicon steel strip or a non-crystal magnetic strip of a specified breadth into an inner ring egg-shape spirakore embryo, and cutting a middle section of the egg-shape spirakore embryo into two symmetric assembling blocks, in order to assemble the two assembling locks in a butted way.

2. A coil-type power factor corrector comprising two assembling blocks which are fixed into a coil structure of the coil-type power factor corrector in a butted way, wherein the two assembling blocks are cut out at a middle section of an egg-shape spirakore embryo which is made by winding a silicon steel strip or a non-crystal magnetic strip of a specified breadth.
